(19) United States
(12) Patent Application Publication
(10) Pub. No.: US 2025/0381722 A1
(43) Pub. Date: Dec. 18, 2025

(54) MULTILAYER FILM

(71) Applicant: Basell Poliolefine Italia S.r.l., Milano (IT)

(72) Inventors: Monica Galvan, Ferrara (IT); Gianni Perdomi, Ferrara (IT)

(73) Assignee: Basell Poliolefine Italia S.r.l., Milano (IT)

(21) Appl. No.: 18/875,925

(22) PCT Filed: Jun. 12, 2023
(86) PCT No.: PCT/EP2023/065565

§ 371 Date: Dec. 17, 2024

(30) Foreign Application Priority Data
Jun. 20, 2022 (EP) 22179929.9

(51) Int. Cl. B29C 49/00; B29C 49/04; B29C 49/22; B29C 49/42; B29K 23/00; B29K 105/00; B29K 509/08; B29L 7/00; B29L 9/00

(52) U.S. Cl. CPC B29C 49/0005; B29C 49/04; B29C 49/22; B29C 49/42836; B29C 2949/3044; B29K 2023/16; B29K 2023/18; B29K 2105/0085; B29K 2105/0088; B29K 2509/08; B29K 2995/0012; B29K 2995/0018; B29K 2995/0097; B29L 2007/008; B29L 2009/00

(57) ABSTRACT

A multilayer film made from or containing a skin layer (A) and a core layer (B), wherein:
the skin layer (A) is made from or containing a polyolefin composition (I) made from or containing:
   (a) from 70% to 95% by weight of a propylene copolymer, having up to and including 10.0% by weight of units deriving from an alpha-olefin and from 10% to 20% by weight of a fraction soluble in xylene at 25° C.; and (b) from 5% to 30% by weight of a butene-1 polymer,
   wherein the amounts of (a) and (b) are based on the total weight of (a)+(b); and
the core layer (B) is made from or containing a copolymer of propylene with up to and including 25% by weight of an alpha-olefin.

### FIELD OF THE INVENTION

In general, the present disclosure relates to the field of chemistry. More specifically, the present disclosure relates to polymer chemistry. In particular, the present disclosure relates to a heat sealable multilayer film.

### BACKGROUND OF THE INVENTION

In some instances, polypropylene heat sealable films are used in packaging applications. In some instances, the packaging applications include cigarette, candy, snack and food wraps. In some instances, polypropylene is used for shrink packaging, hygiene items and sterile wrap used in medical applications.

In some instances, the heat-sealing properties of polypropylene are insufficient for fast packaging systems. In some instances, adding polybutene-1 to polypropylene improves the heat sealing properties of polypropylene. In some instances, multilayers films are made from or containing blends of polypropylene and polybutene-1 in the external sealing layers.

### SUMMARY OF THE INVENTION

In a general embodiment, the present disclosure provides a multilayer film made from or containing a skin layer (A) and a core layer (B), wherein:
the skin layer (A) is made from or containing a polyolefin composition (I) made from or containing:
(a) from 70% to 95% by weight of a copolymer of propylene with an alpha-olefin of formula CH₂═CHR, where R is hydrogen or a linear or branched C2-C8 alkyl, having (1) up to and including 10.0% by weight of units deriving from the alpha-olefin and (2) from 10% to 20% by weight of a fraction soluble in xylene at 25° C., based on the weight of component (a); and
(b) from 5% to 30% by weight of a butene-1 polymer selected from the group consisting of butene-1 homopolymers, butene-1 copolymers having up to and including 5.0% by weight of units deriving from ethylene or propylene, based on the weight of component (b), and mixtures thereof,
wherein the amounts of (a) and (b) are based on the total weight of (a)+(b); and
the core layer (B) is made from or containing a copolymer (c) of propylene with up to and including 25% by weight of an alpha-olefin of formula CH₂═CHR, where R is hydrogen or a linear or branched C2-C8 alkyl, based on the weight of copolymer (c).

In some embodiments, the multilayer film has a comparatively lower seal initiation temperature (SIT) and a comparatively higher hot tack than a multilayer film wherein component (b) is absent from the skin layer(s).

In some embodiments, the multilayer film has higher gloss and lower haze than multilayer films wherein component (b) is absent from the skin layer(s).

In some embodiments, the present disclosure provides a process for making cast and blown films from or containing the multilayer film.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a composition sums up to 100%, unless otherwise specified.

In the present disclosure, when the term “comprising” is referred to a polymer, a plastic material, a polymer composition, mixture or blend, the term should be construed to mean “comprising or consisting essentially of”.

In the present disclosure, the term “consisting essentially of” means that, in addition to the specified components, the plastic material, the polymer composition, the polymer mixture, or the polymer blend may be further made from or containing other components, provided that the characteristics of the plastic material, the polymer composition, the polymer mixture, or the polymer blend are not materially affected by the presence of the other components. In some embodiments, the other components are catalyst residues, antistatic agents, processing aids, melt stabilizers, light stabilizers, antioxidants and antiacids.

In the present disclosure, the term “copolymer” is referred to a polymer deriving from the polymerization of at least two comonomers, that is, the term “copolymer” includes bipolymers and terpolymers.

In the present disclosure, the term “skin layer” is referred to an outermost layer of a multilayer film.

In the present disclosure, the term “core layer” is referred to the innermost layer of a multilayer film.

In some embodiments, the polyolefin composition (I) is made from or containing from 75% to 90% by weight of the propylene copolymer (a) and from 10% to 25% by weight of the butene-1 polymer (b), wherein the amounts of (a) and (b) are based on the total weight of (a)+(b).

In some embodiments, the layers are made from or containing the components in various combinations.

In some embodiments, the polyolefin composition (I) is made from or containing (a) a copolymer of propylene with from 0.5% by weight to 10.0% by weight of units deriving from the alpha-olefin, based on the weight of component (a), and (b) a butene-1 copolymer with from 0.5 to 5.0% by weight of units deriving from ethylene or propylene, based on the weight of component (b). In some embodiments, the alpha-olefin is ethylene. In some embodiments, ethylene is the comonomer of the butene-1 copolymer.

In some embodiments, the propylene copolymer (a) is a propylene-ethylene copolymer, that is, a copolymer consisting of repeating units derived from propylene and ethylene, having at least one of the following properties:
from 2.0% to 10.0% by weight, alternatively from 2.2% to 9.8% by weight, alternatively from 3.0% to 8.0% by weight, alternatively from 4.5% to 7.2% by weight, of units deriving from ethylene, based on the weight of the propylene copolymer (a); or
a melt flow rate MFR(a), measured according to ISO 1133-1:2011 (230° C./2.16 kg), of from 0.1 to 10.0 g/10 min., alternatively from 0.3 to 7.0 g/10 min., alternatively from 0.5 to 3.0 g/10 min; or
from 12% to 20% by weight, alternatively from 14% to 18% by weight, of a fraction soluble in xylene at 25° C. XS(a), based on the weight of the propylene copolymer (a). In some embodiments, the propylene-ethylene copolymer has the previously-described properties.

In some embodiments, the propylene-ethylene copolymer (a) has a melting temperature, measured by DSC according to the method ISO 11357-3:2018, ranging from 1300 to 142° C., alternatively from 131° to 140° C., alternatively from 132° to 137° C.

In some embodiments, the propylene copolymer (a) is made from or containing up to and including 5.0% by weight, alternatively from 0.01% to 5.0% by weight, of an additive selected from the group consisting of nucleating agents, antistatic agents, anti-oxidants, light stabilizers, slipping agents, anti-acids, melt stabilizers, and combinations thereof, the amount of additive being based on the total weight of copolymer (a) made from or containing the additive, the total weight being 100%.

In some embodiments, the propylene copolymer (a) is obtained by polymerizing the relevant monomers, in the presence of a highly stereospecific Ziegler-Natta catalyst systems made from or containing:
(1) a solid catalyst component made from or containing a magnesium halide support on which a Ti compound, having a Ti-halogen bond, is present, and a stereoregulating internal donor;
(2) optionally, an Al-containing cocatalyst; and
(3) optionally, a further electron-donor compound (external donor).

In some embodiments, the solid catalyst component (1) is made from or containing TiCl₄ in an amount securing the presence of from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes and combinations thereof.

In some embodiments, the donors are the esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate and combinations thereof.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the stereoregulating internal electron donor compounds are diesters derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent No. EP361493, European Patent No. EP728769 and Patent Cooperation Treaty Publication No. WO02/100904.

In some embodiments, the internal donor is a mixture of aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the solid catalyst component (1) is prepared as described in European Patent Application No. EP395083A2.

In some embodiments, the catalyst components are prepared as described in U.S. Pat. Nos. 4,399,054, 4,469,648, Patent Cooperation Treaty Publication No. WO98/44009A1, or European Patent Application No. EP395083A2.

In some embodiments, the catalyst system is made from or containing an Al-containing cocatalyst (2) selected from Al-trialkyls. In some embodiments, the Al-containing cocatalyst (2) is selected from the group consisting of Al-triethyl, Al-triisobutyl and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor) and mixtures thereof.

In some embodiments, the polymerization process to obtain the propylene copolymer (a) is carried out in a continuous or batch process. In some embodiments, the polymerization process to obtain the propylene copolymer (a) is carried out in liquid phase or in gas phase.

In some embodiments, the liquid-phase polymerization occurs in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization is carried out in fluidized or stirred, fixed bed reactors. In some embodiments, the gas-phase polymerization is carried out in a multizone circulating reactor (MZCR) as described in European Patent No. EP1012195B1.

In some embodiments and in a single reactor, the polymerization process prepares broad molecular weight olefin polymers, alternatively multimodal olefin polymers. As used herein, the term “multimodal” refers to the modality of the molecular weight distribution. As used herein, the term “multimodal” includes bimodal. In some embodiments, the polymers are obtained from polymerizing olefins in a cascade of two or more polymerization reactors or in different zones of a MZCR reactor under different reaction conditions. The “modality” indicates how many different polymerization conditions were utilized to prepare the polymer, independently of whether this modality of the molecular weight distribution is recognizable as separated maxima in a gel permeation chromatography (GPC) curve or not. In some embodiments and in addition to the molecular weight distribution, the olefin polymer is multimodal, that is, bimodal, in comonomer distribution. In some embodiments, the average comonomer content of polymer chains with a higher molecular weight is higher than the average comonomer content of polymer chains with a lower molecular weight. In some embodiments, identical or similar reaction conditions are employed in the polymerization reactors of the reaction cascade, thereby preparing narrow molecular weight or monomodal olefin polymers.

In some embodiments, the polymerization temperature in the range from 40° C. to 90° C. In some embodiments, the polymerization pressure is from 3.3 to 4.3 MPa, for a process in liquid phase, and from 0.5 to 3.0 MPa, for a process in the gas phase.

In some embodiments, propylene copolymer (a) is commercially available under the trade name Adstif Clyrell, Moplen and Purell from LyondellBasell.

In some embodiments, the butene-1 polymer (b) is a copolymer of butene-1 with ethylene, having at least one of the following properties:
from 1.0% to 4.5% by weight, alternatively from 1.5% to 4.5% by weight, alternatively from 2.0% to 4.0% by weight, alternatively from 2.5% to 3.5% by weight, of units deriving from ethylene, based on the weight of (b); or
a melting temperature Tm(I) of the form I, measured by DSC according to the method ISO 11357-3:2018, lower than 100° C., alternatively ranging from 800 to lower than 100° C., alternatively ranging from 90° to 97° C.; or
a melt flow rate, measured according to ISO 1133-1:2011 (190° C./2.16 kg), ranging from 1.0 to 6.0 g/10 min., alternatively ranging from 2.0 to 5.0 g/10 min, alternatively ranging from 3.0 to 4.5 g/10 min; or
a flexural modulus, measured according to ISO 178:2010, equal to or higher than 80 MPa, alternatively ranging from 80 to 250 MPa, alternatively ranging from 100 to 210 MPa. In some embodiments, the copolymer of butene-1 with ethylene has the previously-described properties.

In some embodiments, the butene-1 copolymer (b) has molecular weight distribution Mw/Mn ranging from 4.0 to 9.0, alternatively from 4.0 to 8.0, alternatively from 4.0 to 7.0, alternatively from more than 4.5 to less than 6.0.

In some embodiments, the butene-1 polymer (b) is made from or containing up to and including 5.0% by weight, alternatively from 0.01% to 5.0% by weight, of an additive selected from the group consisting of nucleating agents, antistatic agents, anti-oxidants, light stabilizers, slipping agents, anti-acids, melt stabilizers, and combinations thereof, the amount of additive being based on the total weight of the butene-1 polymer (b) made from or containing the additive, the total weight being 100%.

In some embodiments, the butene-1 polymer (b) is obtained using a metallocene-based catalyst system.

In some embodiments, the butene-1 polymer (b) is obtainable by polymerizing the relevant monomers in the presence of a Ziegler-Natta catalyst system as described above.

In some embodiments, the polymerization process is carried out with slurry polymerization using as diluent a liquid inert hydrocarbon. In some embodiments, the polymerization process is carried out with solution polymerization. In some embodiments, liquid butene-1 is used as a reaction medium. In some embodiments, the polymerization process is carried out in the gas-phase, operating in one or more fluidized or mechanically agitated bed reactors.

In some embodiments, the polymerization is carried out at temperature of from 200 to 120° C., alternatively from 40° to 90° C. In some embodiments, the polymerization is carried out in one or more reactors. In some embodiments, the reactors are operated under same or different reaction conditions such as concentration of molecular weight regulator, comonomer concentration, temperature, or pressure.

In some embodiments, the catalyst system and polymerization process to obtain the butene-1 polymer (b) are as described in Patent Cooperation Treaty Publication No. WO2004/048424A1.

In some embodiments, the butene-1 polymer (b) is commercially available under the trade name Toppyl from LyondellBasell.

In some embodiments, the polyolefin composition (I) consists of the component (a) and the component (b), optionally containing the additive(s).

In some embodiments, the skin layer (A) consists of the polyolefin composition (I).

In some embodiments, the core layer (B) is made from or containing a copolymer (c) of propylene with up to and including 25% by weight, alternatively from 10% to 25% by weight, of an alpha-olefin of formula CH₂═CHR, where R is hydrogen or a linear or branched C2-C8 alkyl. In some embodiments, the alpha-olefin is ethylene.

In some embodiments, the copolymer (c) of propylene is selected from the group consisting of propylene random copolymers, heterophasic propylene polymers, recycled propylene polymers and combinations thereof. In some embodiments, the copolymer (c) of propylene is a heterophasic propylene polymer.

In some embodiments, the heterophasic propylene polymer is made from or containing:
from 20% to 40% by weight of a polymer fraction (i) made from or containing a propylene polymer selected from the group consisting of propylene homopolymers, propylene copolymers with up to and including 6.0% by weight, alternatively from 0.1% to 6.0% by weight, of an alpha-olefin of formula CH₂═CHR, where R is hydrogen or a linear or branched C2-C8 alkyl, and combinations thereof, based on the weight of the fraction (i); and
from 60% to 80% by weight of a polymer fraction (ii) made from or containing a propylene copolymer with an alpha-olefin of formula CH₂═CHR, where R is hydrogen or a linear or branched C2-C8 alkyl, having up to and including 35.0% by weight, alternatively from 20% to 35.0% by weight, of units deriving from the alpha-olefin and having a solubility in xylene at 25° C. ranging from 45.0% to 75.0% by weight, based on the weight of the fraction (ii),
wherein the amounts of (i) and (ii) are based on the total weight of (i)+(ii).

In some embodiments, the heterophasic propylene polymer is made from or containing:
from 20% to 40% by weight, alternatively from 25% to 35% by weight, of a polymer fraction (i) made from or containing a propylene-ethylene copolymer, having up to and including 6.0% by weight, alternatively from 0.1% to 6.0% by weight, alternatively from 1.5% to 4.5% by weight, of units derived from ethylene, based on the weight of fraction (i); and
from 60% to 80% by weight, alternatively from 65% to 75% by weight, of a fraction (ii) made from or containing a propylene-ethylene copolymer, having up to and including 35.0% by weight, alternatively from 20.0% to 35.0% by weight, alternatively from 23.0% to 30.0% by weight, of units deriving from ethylene and having a solubility in xylene at 25° C. ranging from 55.0% to 75.0% by weight, alternatively from 60.0% to 70.0% by weight, based on the weight of fraction (ii),
wherein the amounts of (i) and (ii) are based on the total weight of (i)+(ii).

In some embodiments, the heterophasic propylene polymer has at least one of the following properties:
a melt flow rate, measured according to the method ISO 1133-1:2011 (230° C./2.16 kg), ranging from 0.1 to 5 g/10 min, alternatively from 0.2 to 3.0 g/10 min., alternatively from 0.3 to 1.2 g/10 min., alternatively from 0.3 to 0.8 g/10 min.; or
a melting temperature, measured by DSC according to the method ISO 11357-3, ranging from 1350 to 148° C.; or
a flexural modulus, measured according to the method ISO 178:2010, equal to or lower than 250 MPa, alternatively equal to or lower than 150 MPa. In some embodiments, the lower limit is 50 MPa for each upper limit.

In some embodiments, the copolymer (c) of propylene is made from or containing up to and including 5.0% by weight, alternatively from 0.01% to 5.0% by weight, of an additive selected from the group consisting of nucleating agents, antistatic agents, anti-oxidants, light stabilizers, slipping agents, anti-acids, melt stabilizers, and combinations thereof, based on the total weight of the copolymer (c), the total weight being 100%.

In some embodiments, the copolymer (c) of propylene is obtained by polymerizing the relevant comonomers in the presence of a highly stereospecific Ziegler-Natta catalyst system and with a polymerization process as described above.

In some embodiments, the heterophasic propylene polymer is obtained by melt blending the fractions (i) and (ii). In some embodiments, the heterophasic propylene polymer is obtained by polymerizing the relevant monomers in the gas-phase in at least two polymerization stages, wherein the second and each subsequent polymerization stage is carried out in the presence of the polymer produced and the catalyst used in the immediately preceding polymerization stage. In some embodiments, the heterophasic propylene polymer is obtained by polymerizing the relevant monomers in a multizone circulating reactor as described in Patent Cooperation Treaty Publication Nos. WO2011/144489 and WO2018/177701. Polymerization temperature and pressure are as described above.

In some embodiments, the heterophasic propylene polymer is a reactor blend produced by sequential polymerization, wherein the amounts of fractions (i) and (ii) correspond to the split between the reactors. In some embodiments, the heterophasic propylene polymer is prepared in a multizone circulating reactor, wherein the amounts of fractions (i) and (ii) correspond to the split between the riser and the downcomer.

In some embodiments, copolymer (c) of propylene is commercially available under the trade name Adflex and Hiflex from LyondellBasell.

In some embodiments, the core layer (B) consists of the copolymer (c) of propylene as described above.

In some embodiments, the multilayer film has a total film thickness ranging from 10 to 200 microns, alternatively from 20 to 140 microns.

In some embodiments and in the multilayer film, the ratio of the thickness of the skin layer (A) to the thickness of the core layer (B) ranges from 1:1 to 1:12, alternatively from 1:2 to 1:6.

In some embodiments, the multilayer film is made from or containing a second skin layer (C). In some embodiments, the second skin layer (C) is made from or containing a second polyolefin composition (I). In some embodiments, an intermediate layer D is interposed between the skin layer A and the skin layer C. In some embodiments, an intermediate layer D is interposed between the skin layer A and the core layer B. In some embodiments, an intermediate layer D is interposed between the skin layer C and the core layer B.

In some embodiments, the skin layer (A) and the skin layer (C) are made from or containing the same polyolefin composition (I). In some embodiments, the skin layer (A) and the skin layer (C) are the same and the multilayer film has an A/B/A structure.

In some embodiments, the multilayer film has a structure A/B/A wherein:
a skin layer (A) and the second skin layer (C) are made from or contain a polyolefin composition (I) made from or containing:
(a) from 70% to 95% by weight, alternatively from 75% to 90% by weight, of a propylene-ethylene copolymer, having
(1) up to and including 10.0% by weight, alternatively from 2.0% to 10.0% by weight, alternatively from 2.2% to 9.8% by weight, alternatively from 3.0% to 8.0% by weight, alternatively from 4.5% to 7.2% by weight, of ethylene, based on the weight of the propylene copolymer (a);
(ii) from 10% to 20% by weight, alternatively from 12% to 20% by weight, alternatively from 14% to 18% by weight, of a fraction soluble in xylene at 25° C., based on the weight of the propylene copolymer (a), and
a melt flow rate, measured according to ISO 1133-1:2011 (230° C./2.16 kg), of from 0.1 to 10.0 g/10 min., alternatively from 0.3 to 7.0 g/10 min., alternatively from 0.5 to 3.0 g/10 min.; and
(b) from 5% to 30% by weight, alternatively from 10% to 25% by weight, of a butene-1 copolymer with ethylene, having
up to and including 5.0% by weight, alternatively from 1.0% to 4.5% by weight, alternatively from 1.5% to 4.5% by weight, alternatively from 2.0% to 4.0% by weight, alternatively from 2.5% to 3.5% by weight, of units deriving from ethylene, based on the weight of (b); and/or
a melting temperature Tm(I), measured according to the method ISO 11357-3:2018, lower than 100° C., alternatively from 800 to lower than 100° C., alternatively from 90° to 97° C.; and/or
a melt flow rate, measured according to ISO 1133-1:2011 (190° C./2.16 kg), ranging from 1.0 to 6.0 g/10 min., alternatively from 2.0 to 5.0 g/10 min, alternatively from 2.5 to 4.5 g/10 min,
a flexural modulus, measured according to ISO 178:2010, equal to or higher than 80 MPa, alternatively from 80 to 250 MPa, alternatively from 100 to 210 MPa,
wherein the amounts of (a) and (b) are based on the total weight of (a)+(b); and
the core layer (B) is made from or containing a heterophasic propylene polymer made from or containing:
from 20% to 40% by weight, alternatively from 25% to 35% by weight, of a polymer fraction (i) made from or containing a propylene-ethylene copolymer, having up to and including 6.0% by weight, alternatively from 0.1% to 6.0% by weight, alternatively from 1.5% to 4.5% by weight, of units derived from ethylene, based on the weight of fraction (i); and
from 60% to 80% by weight, alternatively from 65% to 75% by weight, of a fraction (ii) made from or containing a propylene-ethylene copolymer, having up to and including 35.0% by weight, alternatively from 20.0% to 35.0% by weight, alternatively from 23.0% to 30.0% by weight, of units deriving from ethylene and having a solubility in xylene at 25° C. ranging from 55.0% to 75.0% by weight, alternatively from 60.0% to 70.0% by weight, based on the weight of fraction (ii),
wherein the heterophasic propylene polymer has a total content of ethylene of up to and including 25% by weight, based on the weight of the heterophasic propylene composition, and the amounts of (i) and (ii) are based on the total weight of (i)+(ii).

In some embodiments, the multilayer film is further made from or containing additional layers, interposed between the core layer (B) and the skin layer (A) or the optional skin layer (C).

In some embodiments, the multilayer film is obtained by coextrusion or lamination, wherein in coextrusion multiple extruders are fed with the components for use in the different layers.

In some embodiments, the multilayer film is an unoriented film, alternatively a cast film or a blown film.

In some embodiments, the multilayer film has at least one of the following properties:
a seal initiation temperature (SIT) equal to or lower than 125° C., alternatively ranging from 900 to 125° C., alternatively from 100° to 125° C., alternatively from 1100 to 120° C.; or
a hot tack at 110° C. ranging from 1.0 to 6.0 N, alternatively from 1.5 to 4.0 N. In some embodiments, the multilayer film has the previously-described properties. In some embodiments, the multilayer film is a multilayer cast film or blown film.

In some embodiments, the features are not inextricably linked to each other. In some embodiments, ranges of a feature are combined with ranges of a different feature, independently.

### EXAMPLES

The following examples are illustrative and not intended to limit the scope of the disclosure in any manner whatsoever.

CHARACTERIZATION METHODS: the following methods are used to determine the properties indicated in the description, claims and examples.

Melt Flow Rate: Determined according to the method ISO 1133-1:2011 (230° C./2.16 kg for the propylene polymers and 190° C./2.16 kg for the butene-1 copolymer).

Solubility in xylene at 25° C. for propylene polymers: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XS_{A} values were experimentally determined. The fraction of component (B) soluble in xylene at 25° C. (XS_{B}) was calculated from the formula:

$$X S = W ( A ) \times ( X {S}_{A} ) + W ( B ) \times ( X {S}_{B} )$$

wherein W(A) and W(B) are the relative amounts of components (A) and (B), respectively, and W(A)+W(B)=1.

Comonomer content: ¹³C NMR spectra were acquired on a Bruker AV-600 spectrometer equipped with cryoprobe, operating in the Fourier transform mode at 120° C. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing 1H-13C coupling. The spectrometer was operated at 160.91 MHz. The peak of the S66 carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm. 512 transients were stored in 32K data points using a spectral window of 9000 Hz.

Propylene copolymers: The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$\begin{matrix}\begin{matrix}PPP = 100 {T}_{ββ} / S & \begin{matrix}PPE = 100 {T}_{βδ} / S & EPE = 100 {T}_{δδ} / S\end{matrix}\end{matrix} \\ \begin{matrix}PEP = 100 {S}_{ββ} / S & \begin{matrix}PEE = 100 {S}_{βδ} / S & EEE = 100 ( 0.25 {S}_{γδ} + 0.5 {S}_{δδ} ) / S\end{matrix}\end{matrix} \\ S = {T}_{ββ} + {T}_{βδ} + {T}_{δδ} + {S}_{ββ} + {S}_{βδ} + 0.25 {S}_{γδ} + 0.5 {S}_{δδ}\end{matrix}$$

The molar content of ethylene and propylene was calculated from triads, using the following equations:

$$\begin{matrix}[ E ] mol = EEE + PEE + PEP \\ [ P ] mol = PPP + PPE + EPE\end{matrix}$$

The weight percentage of ethylene content (E % wt) was calculated, using the following equation:

$$E \% wt = \frac{[ E ] mol \times MWE}{( [ E ] mol \times MWE ) + ( [ P ] mol \times MWP )} \times 100$$

wherein
[P] mol=the molar percentage of propylene content;
MWE=molecular weights of ethylene
MWP=molecular weight of propylene.

The total ethylene content C2(tot) and the ethylene content of component (A), C2(A), were measured. The ethylene content of component (B), C2(B), was calculated using the formula:

$$C 2 ( tot ) = W ( A ) \times C 2 ( A ) + W ( B ) \times C 2 ( B )$$

wherein W(A) and W(B) are the relative amounts of components (A) and (B) (W(A)+W(B)=1).

Butene-1 copolymers: The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

$$\begin{matrix}\begin{matrix}BBB = 100 {T}_{ββ} / S & \begin{matrix}BBE = 100 {T}_{βδ} / S & EBE = 100 {P}_{δδ} / S\end{matrix}\end{matrix} \\ \begin{matrix}BEB = 100 {S}_{ββ} / S & \begin{matrix}BEE = 100 {S}_{αδ} / S & EEE = 100 ( 0.25 {S}_{γδ} + 0.5 {S}_{δδ} ) / S\end{matrix}\end{matrix} \\ S = {T}_{ββ} + {T}_{βδ} + {P}_{δδ} + {S}_{αδ} + 0.25 {S}_{γδ} + 0.5 {S}_{δδ}\end{matrix}$$

The total amount of 1-butene and ethylene as molar percent was calculated from triad, using the following relations:

$$\begin{matrix}[ E ] = EEE + BEE + BEB \\ [ B ] = BBB + BBE + EBE\end{matrix}$$

The weight percentage of ethylene content (E % wt) was calculated, using the following equation:

$$E \% wt = \frac{[ E ] mol \times MWE}{( [ E ] mol \times MWE ) + ( [ B ] mol \times MWB )} \times 100$$

wherein
[B] mol=the molar percentage of 1-butene content;
MWE=molecular weights of ethylene
MWB=molecular weight of 1-butene.

Molecular weight distribution Mw/Mn: The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm with particle size 13 μm. The mobile phase used was 1-2-4-trichlorobenzene (TCB) with a flow rate at 1.0 ml/min. The measurements were carried out at 150° C. Solution concentrations were 0.1 g/dl in TCB and 0.1 g/l of 2,6-di-tert-butyl-p-cresole were added, thereby preventing degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the calibration curve. Data acquisition and processing were done using Empower (Waters). The Mark-Houwink relationship was used to determine the molecular weight distribution and the relevant average molecular weights: the K values were KPS=1.21×10-4 dL/g and KPB=1.78×10-4 dL/g for PS and PB respectively, while the Mark-Houwink exponents α=0.706 for PS and α=0.725 for PB were used. For butene-1/ethylene copolymers, the composition was assumed constant in the whole range of molecular weights and the K value of the Mark-Houwink relationship was calculated using a linear combination:

$${K}_{E B} = {x}_{E} {K}_{P E} + {x}_{P} {K}_{P B}$$

where K_{EB} was the constant of the copolymer, K_{PE} (4.06×10⁻⁴, dL/g) and K_{PB} (1.78×10⁻⁴ dl/g) were the constants of polyethylene and polybutene and xE and xB were the ethylene and the butene-1 weight % content. The Mark-Houwink exponent α=0.725 was used for the butene-1/ethylene copolymers.

Melting temperature: measured according to the method ISO 11357-3:2018. To determine the melting temperature of the polybutene-1 crystalline form I (Tm(I)), the sample was melted, kept at 200° C. for 5 minutes, and then cooled down to 20° C. with a cooling rate of 10° C./min. The sample was then stored for 10 days at room temperature. After 10 days, the sample was subjected to DSC. The sample was cooled to −20° C. and then heated at 200° C. with a scanning speed corresponding to 10° C./min. In this heating run, the first peak temperature coming from the lower temperature side in the thermogram was taken as the melting temperature Tm(I).

Flexural Modulus: determined according to the method ISO 178:2010, on injection molded test specimens (80×10×4 mm) obtained according to the method ISO 1873-2:2007 for propylene polymers or on compression molded specimens for butene-1 polymers. Specimens of butene-1 copolymers were conditioned for 10 days at 23° C. before testing.

Seal Initiation Temperature (SIT). Film strips, 6×35 cm, were cut from cast films. Two film strips were superimposed. The strips were sealed with a Brugger Feinmechanik Sealer, model HSG-ETK 745 in the following conditions: smooth metallic sealing bars coated with Teflon™, both bars heated; sealing time 5 sec.; sealing pressure of 0.14 MPa (20 psi); initial sealing temperature of 90° C. Six test specimens were cut from each sealed strip, 15 mm wide, long enough to be claimed in the tensile tester grips. The seal strength at a given temperature was tested at a load cell capacity 100 N, cross speed 100 mm/min, and grip distance 50 mm. The seal strength value was the average of 6 measures on the same specimens. The test was repeated by increasing the temperature by 5° C. When, for three temperatures, the seal strength differed less than 3 N, the plateau was deemed reached and the average plateau strength was calculated. The sealing initiation temperature (SIT) was calculated on the seal plot (force/temperature) as the temperature corresponding to half of the seal strength at the plateau.

Determination of the hot tack. Hot tack was measured after sealing the test specimens with a Brugger HSG Heat-Sealer (with Hot Tack kit) at a pressure of 0.12 MPa (18 psi) for 5 sec. Films were cut at a minimum length of 15×200 mm, superimposed, and sealed at different temperatures, starting at 80° C. and increasing the sealing temperature by 5° C. Immediately after sealing, the test specimen were pulled onto a mandrel by a pulley to split the hot seal seam. For each sealing temperature, the force to split the hot sealed seam at half length (hot tack) was determined using different drop weights made to impact the test specimens.
Haze: ASTM D1003
Gloss: ASTM D2457 (angle 45°)

### Raw Materials:

PP(a): a propylene-ethylene copolymer obtained by a gas-phase polymerization process as described in Example 44 of European Patent No. EP1012195B1, having 6.0% by weight of ethylene-derived units, a solubility in xylene at 25° C. of 16.0% by weight, based on the weight of PP(a), and an MFR(a) of 0.8 g/10 min. (230° C./2.16 kg),

PB1(b): a copolymer of butene-1 with ethylene, having 3.6% by weight of ethylene, a Tm(I) of 94° C., a molecular weight distribution Mw/Mn of 5.6, a melt flow rate of 3.5 g/10 min. (190° C./2.16 kg), and a flexural modulus of 120 MPa. The butene-1 copolymer was obtained by sequential polymerization in two reactors, using butene-1 as liquid medium and a Ziegler-Natta catalyst system according to the Example 11 of Patent Cooperation Treaty Publication No. WO2004/048424, with the following polymerization conditions of the first reactor: temperature of 75° C. and hydrogen/butene feed ratio of 1000 ppmV. After 2.5 hours, the polymerization content of the first reactor was transferred into the second reactor where the copolymerization continued under the same conditions with the ethylene feed discontinued. The polymerization was stopped after 2 hours.

PP(c): a heterophasic propylene copolymer made from or containing 32% by weight of a propylene-ethylene copolymer (i), having 3.2% by weight of ethylene derived units, based on the weight of (i), and 68% by weight of a propylene ethylene copolymer (ii), having 27.0% by weights of units deriving from ethylene and a solubility in xylene at 25° C. of 64% by weight, based on the weight of (ii), wherein the amounts of (i) and (ii) are based on the total weight of (i)+(ii). The heterophasic propylene polymer had a melt flow rate of 0.6 g/10 min. (230° C./2.16 kg), a melting temperature, measured by DSC, of 142° C., and a flexural modulus of 100 MPa. The heterophasic propylene polymer was prepared by a gas-phase polymerization process carried out in two reactors connected in series (H₂/C₃ GPR1: 0.03 mol; C₂/C₃ GPR2: 0.17 mol), in the presence of a Ziegler-Natta catalyst system as described in example 4 of Patent Cooperation Treaty Publication No. WO2012/139897. The amounts of (i) and (ii) corresponded to the split between the reactors.

PP45NP: a premix made from or containing 10% by weight of Silica Sylobloc 45H, which was commercially available from Grace, and 90% by weight of Moplen RP310M, which was commercially available from LyondellBasell, as carrier resin (a modified propylene-ethylene copolymer with a melt flow rate of 8.5 g/10 min (230° C./2.16 kg)).

### Examples E1-E2 and Comparative Example CE3

Blown films, having structure A/B/A and a total film thickness of 100 microns (layers distribution of A=20%/B=60%/A=20%), were prepared on a Collin coex blown film line, wherein the extruders of layers A had a diameter of 30 mm and the extruder of the core layer B had a diameter of 45 mm. The ABA flow was fed to an annular die of 80 mm diameter, with a die gap (lips open) of 1.2 mm. Total output: 12 Kg/h. The annular melt flow was then inflated by air up to a diameter of 200 mm, resulting in a blow-up ratio (BUR=diameter blown film/diameter annular die) of 2.5:1, and subsequently cooled down by chilled air at the exit from a distribution ring, located external and coaxial with the annular die. The cooled tubular film was then collapsed by nip-rolls and collected into reels by a winding unit.

The components of the single layers are reported in Table 1. The mechanical, thermal and optical properties of the blown films are reported in Table 2.

TABLE 1

| | | Skin A | Core B | Skin C |
|---|---|---|---|---|
| E1 | wt. % | 85% PP(a) + | 100% PP(c) | 85% PP(a) + |
| | | 15% PB1(b) | | 15% PB1(b) |
| E2 | wt. % | 83.55% PP(a) + | 100% PP(c) | 83.55% PP(a) + |
| | | 15% PB1(b) + | | 15% PB1(b) + |
| | | 1.45% PP45NP | | 1.45% PP45NP |
| CE3 | wt. % | 100% PP(a) | 100% PP(c) | 100% PP(a) |

TABLE 2

| | | E1 | E2 | CE3 |
|---|---|---|---|---|
| Haze | | 16.7 | 20.1 | 24.4 |
| Gloss at 45° | | 40.3 | 35.4 | 29.3 |
| SIT | ° C. | 115 | 118 | 127 |
| Hot tack at 110° C. | N | 2.5 | 2.0 | 0.2 |

What is claimed is:

1. A multilayer film comprising:
a skin layer (A) and a core layer (B), wherein:
the skin layer (A) comprises a polyolefin composition (I) comprising:
(a) from 70% to 95% by weight of a copolymer of propylene with an alpha-olefin of formula CH₂═CHR, where R is hydrogen or a linear or branched C2-C8 alkyl, having
(1) up to and including 10.0% by weight of units deriving from the alpha-olefin, and
(2) from 10% to 20% by weight of a fraction soluble in xylene at 25° C., based on the weight of (a); and
(b) from 5% to 30% by weight of a butene-1 polymer selected from the group consisting of butene-1 homopolymers, butene-1 copolymers having up to and including 5.0% by weight of units deriving from ethylene or propylene, based on the weight of (b), and mixtures thereof,
wherein the amounts of (a) and (b) are based on the total weight of (a)+(b);
the core layer (B) comprises a copolymer (c) of propylene with up to and including 25% by weight of an alpha-olefin of formula CH₂═CHR, where R is hydrogen or a linear or branched C2-C8 alkyl, based on the weight of the copolymer (c).

2. The multilayer film according to claim 1, wherein the polyolefin composition (I) comprises from 75% to 90% by weight of the propylene copolymer (a) and from 10% to 25% by weight of the butene-1 polymer (b), wherein the amounts of (a) and (b) are based on the total weight of (a)+(b).

3. The multilayer film according to claim 1, wherein the polyolefin composition (I) comprises (a) a copolymer of propylene with from 0.5% by weight to 10.0% by weight of units deriving from the alpha-olefin, based on the weight of (a), and (b) a butene-1 copolymer with from 0.5 to 5.0% by weight of units deriving from ethylene or propylene, based on the weight of (b).

4. The multilayer film according to claim 1, wherein the propylene copolymer (a) is a propylene-ethylene copolymer, having at least one of the following properties:
from 2.0% to 10.0% by weight of units deriving from ethylene, based on the weight of the propylene copolymer (a); or
a melt flow rate, measured according to 1133-1:2011 (230° C., 2.16 Kg), of from 0.1 to 10.0 g/10 min.; or
from 12% to 20% by weight of a fraction soluble in xylene at 25° C. XS(a), based on the weight of the propylene copolymer (a).

5. The multilayer film according to claim 1, wherein the butene-1 polymer (b) is a copolymer of butene-1 with ethylene, having at least one of the following properties:
from 1.0% to 4.5% by weight of units deriving from ethylene, based on the weight of (b); or
a melting temperature Tm(I), measured by DSC according to the method ISO 11357-3:2018, lower than 100° C.; or
a melt flow rate, measured according to ISO 1133-1:2011 (190° C./2.16 kg), ranging from 1.0 to 6.0 g/10 min.; or
a flexural modulus, measured according to ISO 178:2010, equal to or higher than 80 MPa.

6. The multilayer film according to claim 1, wherein the copolymer (c) of propylene is a heterophasic propylene polymer comprising:
from 20% to 40% by weight of a polymer fraction (i) comprising a propylene polymer selected from the group consisting of propylene homopolymers, propylene copolymers with up to and including 6.0% by weight of an alpha-olefin of formula CH₂═CHR, where R is hydrogen or a linear or branched C2-C8 alkyl, based on the weight of the fraction (i), and combinations thereof; and
from 60% to 80% by weight of a polymer fraction (ii) comprising a propylene copolymer with up to and including 35.0% by weight of an alpha-olefin of formula CH₂═CHR, where R is hydrogen or a linear or branched C2-C8 alkyl and having a solubility in xylene at 25° C. ranging from 45.0% to 75.0% by weight, based on the weight of the fraction (ii),
wherein the amounts of (i) and (ii) are based on the total weight of (i)+(ii).

7. The multilayer film according to claim 6, wherein the copolymer (c) of propylene is a heterophasic propylene polymer comprising:
from 20% to 40% by weight of a polymer fraction (i) comprising a propylene-ethylene copolymer comprising up to and including 6.0% by weight of units derived from ethylene, based on the weight of fraction (i); and
from 60% to 80% by weight of a fraction (ii) comprising a propylene-ethylene copolymer comprising up to and including 35.0% by weight of units deriving from ethylene and having a solubility in xylene at 25° C. ranging from 55.0% to 75.0% by weight, based on the weight of fraction (ii),
wherein the amounts of (i) and (ii) are based on the total weight of (i)+(ii).

8. The multilayer film according to claim 1, wherein the total film thickness ranges from 10 to 200 microns.

9. The multilayer film according to claim 1, wherein the ratio of the thickness of the skin layer (A) to the thickness of the core layer (B) ranges from 1:1 to 1:12.

10. The multilayer film according to claim 1, further comprising a second skin layer (C) comprising a second polyolefin composition (I).

11. The multilayer film according to claim 10, wherein the skin layer (A) and the second skin layer (C) comprise the same polyolefin composition (I).

12. The multilayer film according to claim 10, wherein the skin layer (A) and the second skin layer (C) are the same and the multilayer film has an A/B/A structure.

13. The multilayer film according to claim 1, wherein the film is unoriented.

14. The multilayer film according to claim 13, wherein the film is a cast film or a blown film.

15. The multilayer film according to claim 13, having at least one of the following properties:
a seal initiation temperature (SIT) equal to or lower than 125° C.; or
a hot tack at 110° C. ranging from 1.0 to 6.0 N.
